(19) United States
(12) Patent Application Publication
(10) Pub. No.: US 2015/0299902 A1
(43) Pub. Date: Oct. 22, 2015

(54) QUENCH TUBE FOR POLYMER FIBER EXTRUSION

(71) Applicant: NV BEKAEERT SA, Zwevegem (BE)

(72) Inventors: Frank VERSCHAEVE, OTEGEM (BE); Stefan VANDENDIJK, TONGEREN (BE); Marie NGUYEN, DIEST (BE); Jeremie DEBAERDEMAEKER, BEVEREN-LEIE (BE)

(73) Assignee: NV BEKAERT SA, ZWEVEGEM (BE)

(21) Appl. No.: 14/654,237

(22) PCT Filed: Jan. 23, 2014
(86) PCT No.: PCT/EP2014/051337

§ 371 Date: Jun. 19, 2015

(30) Foreign Application Priority Data
Feb. 4, 2013 (EP) 13153817.5

(51) Int. Cl. D01D 5/088; B23K 9/10; B23K 31/02

(52) U.S. Cl. CPC D01D 5/088; B23K 31/027; B23K 9/1081

(57) ABSTRACT

The quench tube comprises a cylindrical wall through which quenching air flows when the quench tube is in use. The cylindrical wall comprises metal fibers in a nonwoven fiber structure. The metal fibers are bonded to each other at contacting points by means of metallurgical bonds thereby forming a three dimensionally bonded fiber structure.

### TECHNICAL FIELD

The invention relates to the field of quench tubes used in polymer fiber or polymer filament extrusion, and to a method to manufacture such quench tubes.

### BACKGROUND ART

The use of quench tubes in polymer fiber extrusion is known, e.g. in the extrusion process for producing POY (Partially Oriented Yarn) or FDY (Fully Drawn Yarn) polyester multifilament yarns. After extrusion, the fibers or filaments pass through a quench zone which comprises one or more quench tubes. Through the walls of the quench tube, from the inside out or from the outside in—air is led that cools and sometimes also draws the fibers or filaments.

Different types of quench tubes exist and have been described.

GB1382499 mentions quench tubes made of a porous material, such as ceramic or sintered metal powder. Sintered bronze powder is indicated as a specific example for quench tubes.

EP1491663 lists quench tubes manufactured from multilayer cellulose, multilayer wire netting, sintered metal powder or ceramics, and multilayer perforated plate.

CN2861195 describes a quench tube consisting out of an outer layer of a perforated metal tube and an inner layer of a twill weave metal wire mesh.

CN2528783Y describes a quench tube consisting out of an inner layer of a perforated stainless steel sheet of porosity 12-15%, a number of layers of woven stainless steel wire meshes of porosity 25-35%, and an outer layer of a perforated stainless steel sheet of porosity 22-30%.

An example of a commercially available quench tube is made of a helically wound cellulose paper or nonwoven ribbon impregnated with phenolic resin which is heat cured to form a paper quench tube. The air distribution occurs through the innumerable minute gaps formed between the layers of helically wound ribbon. The numerous distributed pores run straight from the outer circumference to the inner core of the quench tube.

Quench tubes have to allow uniform distribution of air over their full surface. It is a problem of the quench tubes of the prior art that the quench tubes are not optimal in terms of uniformity of distribution of air.

### DISCLOSURE OF INVENTION

The primary object of the invention is to provide an improved quench tube. It is a specific objective to provide a quench tube that provides an improved and excellent uniformity of the flow distribution over its full outflow surface.

A first aspect of the invention is a quench tube for quenching polymer fibers in fiber extrusion. Such polymer fibers can be filaments or staple fibers. The quench tube comprises a cylindrical wall through which quenching air flows when the quench tube is in use. The cylindrical wall can have a circular cross section, or another cross sectional shape such as elliptical. The cylindrical wall comprises metal fibers in a nonwoven fiber structure. The metal fibers are bonded to each other at contacting points by means of metallurgical bonds thereby forming a three dimensionally bonded fiber structure.

Quench tubes according to the invention have the benefit that they have an excellent uniformity of the quench flow over the full outflow surface of the quench tube, in combination with a low pressure drop. It is possible to make quench tubes that are shorter than the quench tubes of the prior art. Quench tubes with metal wire meshes and/or perforated metal sheets have less pores and the pores are of higher sizes. Such quench tubes also have an important discontinuity at joining edges of the metal wire meshes and/or perforated metal sheets; both aspects result in a non-uniform quench flow compared to the quench tube of the invention.

It is a further benefit that the quench tubes of the invention can be cleaned while maintaining after cleaning the excellent uniformity of quench flow distribution. Quench tubes with metal wire meshes and/or perforated metal sheets can also be cleaned, however, after cleaning, the quench flow is even less uniform than before cleaning. This is believed to be because of the different size of number of pores in the quench tube of the prior art compared to the quench tube of the invention. The quench tube of the invention has a large number of small pores, therefore a remaining soil particle after cleaning has less effect on the flow distribution as the quench air flow can find more easily a path around the pore with the remaining soil particle.

It is a further benefit of quench tubes of the invention that they are inflammable. Quench tubes made of a helically wound cellulose paper or nonwoven ribbon impregnated with phenolic resin which is heat cured are flammable.

For the invention, preferred are metallurgical bonding techniques in which no additional bonding material or bonding agent is added, but where only the metal fibers are used to create the bonding. Examples of such metallurgical bonds are sinter bonds (in which a bond is created by means of diffusion between contacting fibers in a sintering process) or welded bonds (where contacting fibers are bonded by means of local melting and re-solidifying). An example of an appropriate welding technique is capacity discharge welding (CDW).

Preferred are metal fibers with an equivalent fiber diameter between 2 and 40 micrometer, more preferred are metal fibers with an equivalent fiber diameter between 12 and 40 micrometer, even more preferred are metal fibers with an equivalent fiber diameter between 18 and 25 micrometer. Such quench tubes have even better quenching results, in terms of distribution of quenching air.

With equivalent diameter of a fiber is meant the diameter of a circle that is having the same area as the cross section of the fiber.

In a preferred embodiment, a majority of the metal fibers at least partially encircle the axis of the quench tube. Preferably at least 50 percent, and more preferably at least 85 percent of the fibers at least partially encircling the axis.

With a metal fiber at least partially encircles the axis of the quench tube is meant that it passes partially around this axis. This can be seen and measured by making a cross section perpendicular to the axis of the cross section and observing the projection line of the fibers on a plane perpendicular to the axis of the quench tube. A metal fiber is at least partially encircling the axis when the projection line of the fiber on the plane perpendicular to the axis of the cross section is concave towards the axis; and when the projection line is for 360° degrees encircling the axis and/or when the projection line is longer than half of the length of the fiber in case of staple fibers.

Preferred are stainless steel fibers. Even more preferred are stainless steel fibers according to AISI 304 or AISI 316.

The metal fibers can e.g. have a circular or a polygonal cross section, e.g. a rectangular or a hexagonal cross section.

The metal fibers can e.g. be produced via single end drawing, via bundled drawing (see e.g. in U.S. Pat. No. 2,050,298, U.S. Pat. No. 3,277,564 and in U.S. Pat. No. 3,394,213)—particularly interesting for producing stainless steel fibers, via shaving (see e.g. in U.S. Pat. No. 4,930,199), via machining or via extrusion from a melt. A hexagonal cross section of the fibers is preferred. Metal fibers, and especially stainless steel fibers, with hexagonal cross section can be obtained via the bundled drawing production technology.

In a preferred embodiment, the metal fibers are part of a fiber structure which is coiled around the central axis of the quench tube.
such fiber structure can be a staple fiber structure.
such fiber structure can also be a nonwoven fiber web, comprising staple fibers or filaments (fibers of virtually infinite length). When such fiber structure is a nonwoven fiber web, it is preferred when it has—in the quench tube—the width of the quench tube. The number of layers coiled can e.g. be 10 to 100, preferably 20 to 45, more preferably 20 to 40.
such a fiber structure can also comprise at least one fiber bundle, preferably with endless metal fibers or with metal fibers having an average length between 4 and 30 cm, and preferably with crimped metal fibers.

Preferably such fiber bundle is a combination of metal fibers all oriented substantially in the length direction of the fiber bundle. An example is a bundle of crimped metal filaments (fibers of virtually infinite length). Preferably the coiling is performed building up a number of layers over the wall thickness of the quench tube, e.g. 10 to 100 layers, preferably 20 to 45 layers, more preferably 20 to 40 layers.

Such coiling contributes to the improvement of the uniformity of quench air distribution over the outflow surface of the quench tube.

When using staple fibers for the different embodiments of the invention, preferred staple fibers have an average length ranging from 0.6 cm to 6 cm.

A preferred porosity range of the quench tube of the invention in order to obtain a quench tube with excellent quench air distribution is within the range of 60% to 95%; more preferably 85 to 95%.

In an even more preferred embodiment, the cylindrical wall of the quench tube is over its full wall thickness consisting out of the metal fibers in a nonwoven fiber structure. Such a quench tube has shown to provide the best results in terms of uniformity of the quench air distribution.

A preferred wall thickness range of the quench tube is 5 to 25 mm, more preferred 5 to 10 mm.

A second aspect of the invention is a method to make a quench tube as in the first aspect of the invention. The method comprises the steps of
providing an elongated metal fiber structure,
coiling the elongated metal fiber structure, around a core (e.g. around a reel), in order to obtain a cylindrical shape of the coiled elongated metal fiber structure. Preferably the coiling is performed building up a number of layers over the wall thickness of the quench tube.
metallurgically bonding the so-obtained cylindrical shape in order to create metallurgical bonds (e.g. sinter bond by means of sintering; or welded bonds by means of welding, e.g. by means of capacitor discharge welding) at contacting points between metal fibers, and
remove the core.

The method is an economic way of making a quench tube of good uniformity of quench flow. Such coiling contributes to the improvement of the uniformity of quench air distribution over the outflow surface of the quench tube.

In a specific embodiment of the method, the method comprises the steps of
providing a mesh having at least a mesh leading edge;
before metallurgically bonding the metal fiber structure obtained by coiling, cylindrically winding said mesh around said wound fiber structure, parallel to said mesh leading edge;
removing said mesh from around said metallurgically bonded cylindrical shape.

In a specific embodiment of the method, the elongated metal fiber structure is a metal fiber nonwoven web having at least a leading edge; and the metal fiber nonwoven web is cylindrically wound, parallel to said leading edge, until the predetermined diameter is obtained. Preferred is when the width of the web is equal or larger than the quench tube that is to be made.

E.g. 10 to 100, preferably 20 to 50, more preferably 20 to 45 layers, more preferably 20 to 40 can be obtained in the quench tube in coiling the metal fiber nonwoven web.

The metal fiber nonwoven web can e.g. comprise staple metal fibers or metal fiber filaments.

In another specific embodiment of the method the metal fiber structure is comprising a metal fiber bundle or is a metal fiber bundle. Preferably such a fiber bundle is a combination of metal fibers all oriented substantially in the length direction of the fiber bundle. An example is a bundle of crimped metal filaments (fibers of virtually infinite length).

The fiber bundle or fiber bundles can be wrapped around the core, whereby the wrapping is moved along the axis of the core in order to build up the quench tube.

A third aspect of the invention is a polymer fiber extrusion apparatus, comprising a quench tube as in the first aspect of the invention, installed at the extrusion die of the extrusion apparatus, in order to quench the polymer fibers or polymer filaments after their extrusion. The polymer fiber extrusion apparatus can have a flow of the quenching air inside out the quench tube or outside in the quench tube.

For use in extrusion apparatuses that have an inside-out flow of the quench air, internal diameters of the quench tube in the range of 60 to 165 mm are preferred, even more preferably 60 to 100 mm. For use in extrusion apparatus that have an outside-in flow of the quench air, internal diameters of the quench tube in the range of 200 to 350 mm are preferred.

### BRIEF DESCRIPTION OF FIGURES IN THE DRAWINGS

FIG. 1 shows an example of a quench tube according to the invention.

FIG. 2 shows an example of a polymer fiber extrusion apparatus comprising a quench tube of the invention.

### MODE(S) FOR CARRYING OUT THE INVENTION

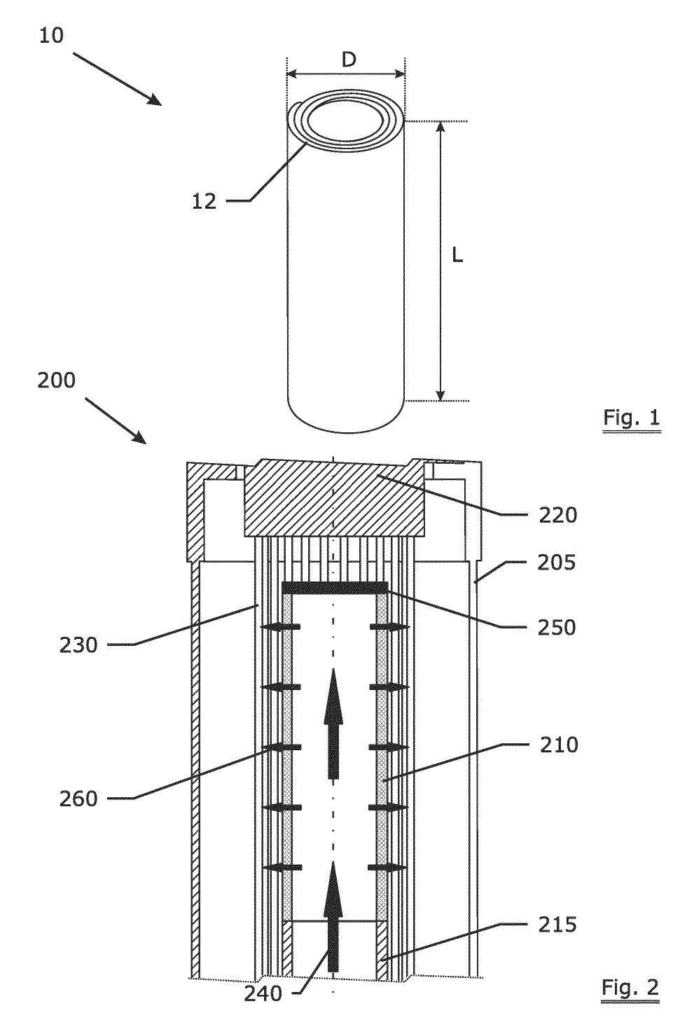

FIG. 1 shows an example of a quench tube 10 according to the invention. L indicates the length of the quench tube, e.g. 150 mm and D its outer diameter. It is made via circular winding (coiling) of a unsintered nonwoven stainless steel fiber web around a core (e.g. around a reel) of the appropriate diameter. A carded, air-laid or wet-laid nonwoven stainless steel fiber web can advantageously be used. The web is wound to obtain a number of layers 12 until the required diameter of the cylindrical shape of the coiled elongated metal fiber structure for the quench tube is obtained. The amount of layers used contributes to obtain the uniform quench air distribution over the outflow surface of the quench tube. The metal fibers of this coiled elongated metal fiber structure are then metallurgically bonded, e.g. by means of sintering or by means of welding without use of additional bonding material. Such welding can e.g. be done by means of capacitor discharge welding. The core is removed afterwards. Stainless steel fibers according to AISI 304 or AISI 316 can be used. Such fibers can be bundle drawn fibers, singe end drawn wires, shaved fibers or machined fibers. Examples of equivalent diameter of fibers that can e.g. be used are 20 micrometer, 22 micrometer, 30 micrometer or 40 micrometer.

Quench tubes with a wall thickness of 10 mm have been made. Using a stainless steel fiber web with a weight of 300 g/m², when coiling 27 layers and to a wall thickness of 10 mm; a porosity of the quench tube of 90% was obtained.

Using a stainless steel fiber web with a weight of 300 g/m², when coiling 21 layers and to a wall thickness of 10 mm; a porosity of the quench tube of 92% was obtained.

Using a stainless steel fiber web with a weight of 300 g/m², when coiling 40 layers and to a wall thickness of 10 mm; a porosity of the quench tube of 85% was obtained.

An example is a quench tube with internal diameter 86 mm and outer diameter D 106 mm.

The uniformity of quench air flow has been tested using a pressure sensor at the exit of the quench tube. The pressure sensor was located at different positions along the length of the quench tube and along the circumference of the cross section and measurements of the air pressure were performed.

The quench tubes of the invention have shown to provide a remarkable uniform distribution of air over their full surface, along the length of the quench tube as well as along the circumference of cross sections perpendicular to the axis of the quench tube. The remarkably uniform distribution of air was maintained after cleaning by treatment in hot solvent to remove impurities from the quench tube trapped in it during its use.

Other tests showed that compared to a quench tube made of a helically wound cellulose paper or nonwoven ribbon impregnated with phenolic resin which is heat cured afterwards, the uniform distribution of quench air flow could be obtained at a lower air pressure.

FIG. 2 shows an example of a polymer fiber extrusion apparatus comprising a quench tube of the invention. The extrusion apparatus 200 comprises a frame 205, a quench tube 210 according to the invention, e.g. as shown in FIG. 1 and as described in the examples, on supporting tubing 215 and an extrusion die 220. Polymer filaments 230 are extruded through the extrusion die 220. Such filaments 230 can be cut afterwards to provide staple fibers, or collected for further use as filaments of virtually infinite length. Quench air is supplied through piping 215 in the direction of arrow 240 to the quench tube 210. The quench tube 210 has an end cap 250 to close off the quench tube 210 at its end opposite to the entrance of the quench air in the quench tube 210. Such end cap 250 can be a plastic or metal disc that is removably put at the end of the quench tube 210. The quench air flows in the direction of arrows 260 through the quench tube 210 quenching the filaments 230.

By removing the quench tube 210 out of the extrusion apparatus 200 and removing the end cap 250, it is possible to clean the quench tube 210 of the invention, e.g. by washing in a solvent at elevated temperatures which can be in the range of 280-400° C.

FIG. 2 shows an example of an extrusion apparatus in which the quench tube has an inside-out air quench flow. In a similar way extrusion apparatuses can be equipped with a quench tube of the invention with an outside-in quench flow, wherein the filaments are extruded inside the quench tube.

1-10. (canceled)

11. A quench tube for quenching polymer fibers in fiber extrusion,
wherein said quench tube comprises a cylindrical wall through which quenching air flows when the quench tube is in use;
wherein said cylindrical wall comprises metal fibers in a nonwoven fiber structure; and
wherein said metal fibers are bonded to each other at contacting points by means of metallurgical bonds thereby forming a three dimensionally bonded fiber structure.

12. The quench tube as in claim 11, wherein a majority of said metal fibers at least partially encircle the axis of said cylindrical wall.

13. The quench tube as in claim 11, wherein said metal fibers are part of a fiber structure, wherein the fiber structure is coiled around the central axis of the quench tube.

14. The quench tube as in claim 13, wherein the fiber structure is a nonwoven fiber web.

15. The quench tube as in claim 13, wherein the fiber structure comprises at least one fiber bundle.

16. The quench tube as in claim 14, wherein the fiber structure comprises at least one fiber bundle.

17. The quench tube as claim 11, wherein the porosity of the quench tube is within the range of 60 to 95%.

18. The quench tube as claim 11, wherein said cylindrical wall consists over its full wall thickness out of said metal fibers in a nonwoven fiber structure.

19. A method to manufacture a quench tube as in claim 11, comprising the steps of
providing an elongated metal fiber structure,
coiling said elongated metal fiber structure around a core, in order to obtain a cylindrical shape of the coiled elongated metal fiber structure,
metallurgically bonding the so-obtained cylindrical shape in order to create metallurgical bonds at contacting points between metal fibers, and
removing the core.

20. The method as in claim 19, wherein said method comprises the steps of
providing a mesh having at least a mesh leading edge;
before metallurgically bonding the fiber structure, cylindrically winding said mesh around said wound fiber structure, parallel to said mesh leading edge;
removing said mesh from around said metallurgically bonded cylindrical shape.

21. A polymer fiber extrusion apparatus, comprising a quench tube as in claim 11, installed at the extrusion die of said extrusion apparatus, in order to quench the polymer fibers or polymer filaments after their extrusion.
